(19) United States
(12) Patent Application Publication
(10) Pub. No.: US 2026/0161885 A1
(43) Pub. Date: Jun. 11, 2026

(54) METHOD AND SYSTEM FOR EXTRACTING AND CORRELATING FUNCTIONAL VALUES AND STRUCTURAL INFORMATION IN WORKSHEET DATA ENVIRONMENT

(71) Applicant: SR AI INC, Montreal (CA)

(72) Inventors: Oleksandr SOKOLOV, Toronto (CA); Paul DAIGLE, Montreal (CA)

(73) Assignee: SR AI INC, Montreal (CA)

(21) Appl. No.: 19/181,432

(22) Filed: Apr. 17, 2025

Related U.S. Application Data
(60) Provisional application No. 63/636,970, filed on Apr. 22, 2024.

(51) Int. Cl. G06F 40/18; G06Q 10/0639

(52) U.S. Cl. CPC G06F 40/18; G06Q 10/06393

(57) ABSTRACT

The present method extracts and correlates functional values and structural information from a worksheet data environment. The method extracts the functional values from the worksheet data environment. For each functional value, the method: extracts structural information provided in the worksheet data environment for the functional value, extracts data elements and structural information of the data elements onto which a function is executed to generate the functional value, interconnects the functional value with the corresponding structural information, interconnects the functional value with the data elements onto which the function is executed, and interconnects the structural information of the data elements onto which the function is executed to obtain the functional value.

### TECHNICAL FIELD

The present disclosure relates to the field of worksheet data environments, and more particularly to a method and system for extracting and correlating functional values and structural information from worksheet data environments.

### BACKGROUND

Stored digital information can fall under one of three structural categories: structured data, semi-structured data, and unstructured data. Structured data is adapted for processing by machine learning models and Artificial Intelligence (AI) engines, and usually refers to standardized information provided as text, data provided with metadata, or data stored in a database. Semi-structured data typically refers to data that is obtained from software products such as worksheets and spreadsheets, Portable Document Format (PDF) documents, data generated by Internet-of-Things devices, data generated by mobile applications, etc. Unstructured data refers to data that has no inherent or inferable structure.

Worksheet data environments are suited for creating relationships and/or dependencies between data elements therein. Extracting information from worksheet data environments typically consists of extracting a value from a cell and the structural information for the cell from which the value is extracted.

There is therefore a need for a new method and system for extracting and correlating functional values and structural information in worksheet data environments.

### SUMMARY

According to a first aspect, the present disclosure relates to a method for extracting and correlating functional values and structural information from a worksheet data environment. The method comprises extracting, by a computer, the functional values from the worksheet data environment. For each functional value, the computer: extracts structural information provided in the worksheet data environment for the functional values, extracts data elements and structural information of the data elements onto which a function is executed to generate the functional value, interconnects the functional value with the corresponding structural information, interconnects the functional value with the data elements onto which the function is executed, and interconnects the structural information of the data elements onto which the function is executed to obtain the functional value.

In a particular aspect of the method, the worksheet data environment is at least one of: a spreadsheet, a worksheet, and a workbook.

In another aspect, the structural information comprises at least one of: a row name, a column name, a title, visual proximate data elements and corresponding structural information, formatting information, and worksheet data environment hardcoded information.

In yet another aspect, the method further interconnects each of the functional values with visually proximate data elements and their corresponding structural information.

In another particular aspect, the function is one of: a financial function, a statistical function, a lookup function, a date and time function, a logical function, a linking function, or a hard-coded function.

In another particular aspect, the extracted and correlated functional values and structural information are presented as at least one of: a node graph, a knowledge graph, or text.

According to a second aspect, the present disclosure relates to a method for extracting coherent compound information from a worksheet data environment. The method comprises accessing by a computer the worksheet data environment. The method further compounds coherent information from the semi-structured data by extracting, by the computer, functional values from the worksheet data environment. For each functional value, the computer further: extracts structural information provided in the worksheet data environment for the functional values, extracts data elements and structural information of the data elements onto which a function is executed to generate the functional value, interconnects the functional value with the corresponding structural information, interconnects the functional value with the data elements onto which the function is executed, and interconnects the structural information of the data elements onto which the function is executed to the functional value.

In an aspect, the worksheet data environment is at least one of: a spreadsheet, a worksheet, and a workbook, and the structural information includes at least one of: a row name, a column name, a title of a worksheet, a title of a section, a cell format, visually proximate data, and the worksheet data environment hardcoded information.

In any of the previous aspects, the compound information consists of a comparison for a type of financial information, a comparison for a type of value, or a Key Performance Indicator (KPI).

In another aspect, the present disclosure relates to a system executing the method.

In yet another aspect, the present disclosure relates to a computer-readable medium storing instructions that, when executed by a computer, cause it to perform the method.

### BRIEF DESCRIPTION OF THE DRAWINGS

Embodiments of the disclosure will be described by way of example only with reference to the accompanying drawings, in which:

FIG. 1 illustrates a method for extracting and correlating functional values and structural information from worksheet data environments;

FIG. 2 illustrates an example of semi-structured data on a worksheet;

FIG. 3 illustrates an example of node graph for the semi-structured data of FIG. 2 in accordance with prior art methods of node graph generation;

FIG. 4 illustrates an example of node graph for the semi-structured data of FIG. 2 using the present method and system for extracting and correlating the functional values and structural information; and

FIG. 5 illustrates a system for extracting and correlating functional values and structural information from worksheet data environments.

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

Various aspects of the present disclosure generally address the extraction of functional values and functional values information from worksheet data environments.

The following terminology is used throughout the present disclosure:
Compound information: information which cannot be directly extracted from the worksheet data environment but requires a combination of data element, structural information, and interconnection.
Computer: any electronic device equipped with at least one processor to execute instructions, such as for example a personal computer, a server, a cloud-based server, a tablet, or any device.
Data element: information provided in a cell of a worksheet data environment, a data element may correspond to a fixed value or a functional value.
Function: code, macro, link, hardcode, or an operator applied to at least one data element of the worksheet data environment for generating a functional value.
Functional value: value that is not fixed, but results from execution of a function.
Proximal metadata: proximate data elements and the corresponding structural data to the data element extracted.
Worksheet data environment: any type of digital support or environment storing data in which the meaning or value of some of the data elements stored therein depends on at least one function, examples of worksheet data environment include, for example, spreadsheets, worksheets, and workbooks.
Structural information: information provided in the worksheet data environment related to the data element extracted, such as for example row title, column title, worksheet title, section title, hard-coded information for the worksheet data environment, or any other structure-related information for the data element extracted.

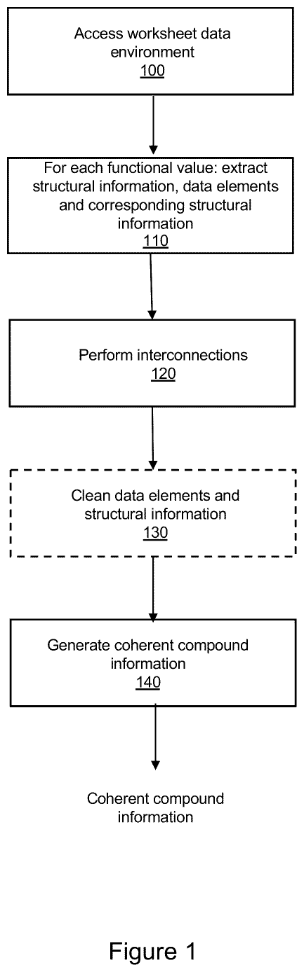

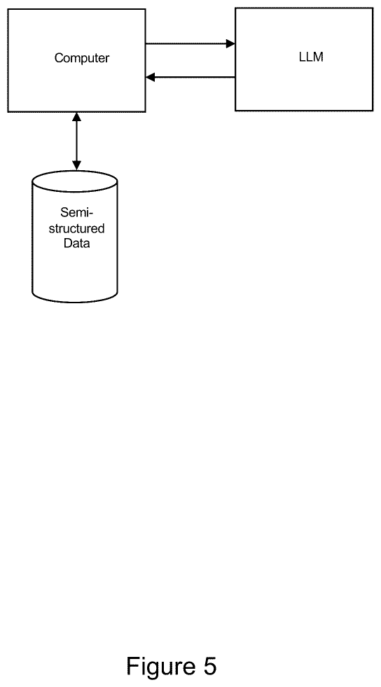

Reference is made concurrently to FIGS. 1 to 5, illustrating aspects of the present method and system. To assist in the description of the present method and system, reference will be made to an example. This example should not be construed to limit the scope of the present method and system, nor limit the scope of the terminology used and defined hereinabove.

The present method and system are adapted for extracting and correlating functional values and structural information from a worksheet data environment. In the context of the present method and system, the expression “functional value” is meant to refer to a meaning or value obtained by executing at least one function. Functions are powerful tools in worksheet data environments. Functions for example interconnect, link or perform operations concurrently on multiple data elements which are not necessarily adjacent, to generate a function value. Some functions are identified by a function name a predetermined syntax. Other functions affect operations, by means of operators to one or multiple data elements. Examples of functions include financial functions, statistical functions, lookup functions, date and time functions, and logical functions, operators applied to data element(s).

For the present example, the worksheet data environment is a spreadsheet, and the data elements in the columns 2020, 2021, 2022, and 2023 are functional values relating respectively to revenues, expenses, and profits. In worksheet data environments, data like yearly revenues, expenses, and profits are not fixed values but rather the results of at least one function, thus functional values. However, although functional values are simple to extract, such functional values provide little information on the data elements used to calculate the functional values, including the corresponding structural data. Furthermore, the function values extracted can be the result of a chain of functions consecutively performed on various data elements with their corresponding structural data.

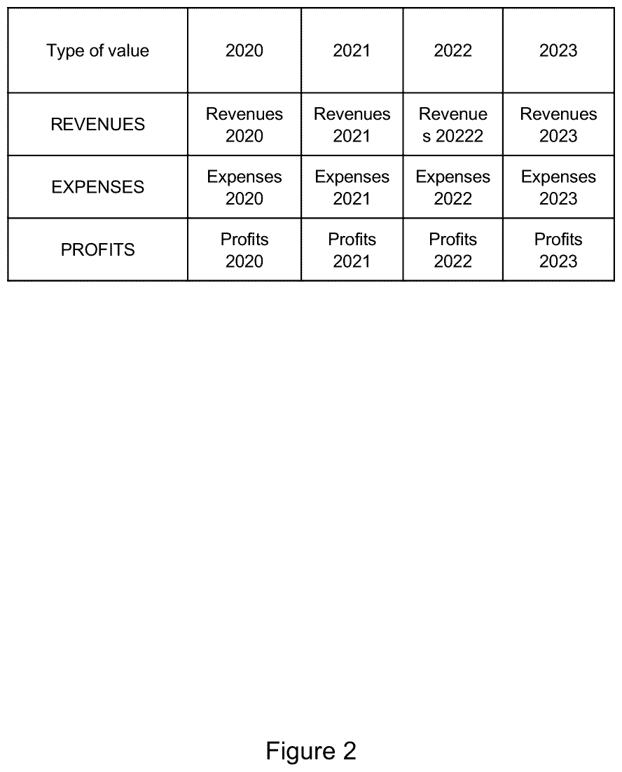

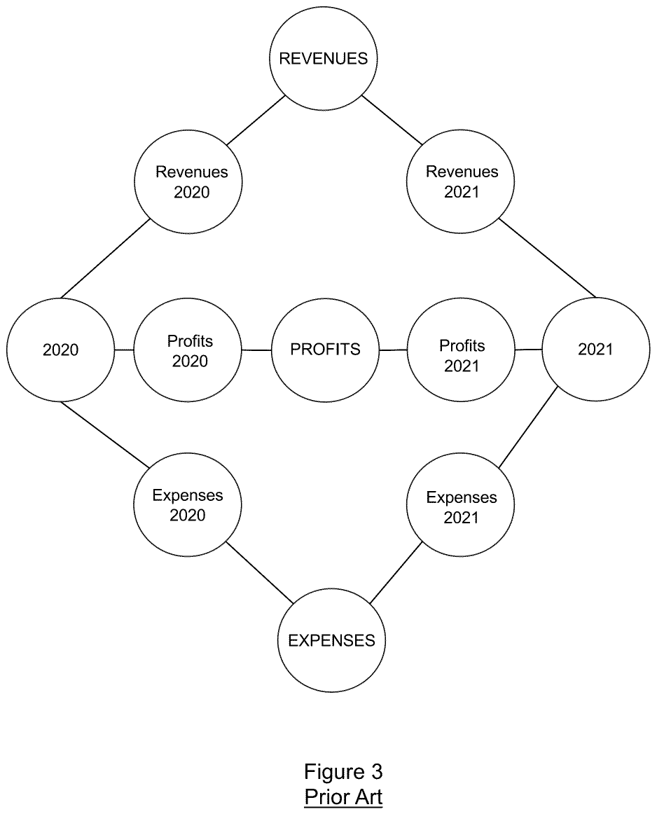

Reference is now made to FIG. 3 which illustrates a node graph generated by a prior art node graph generation tool for the first three columns of FIG. 2, namely the column titled “Type of value”, the column titled “2020” and the column titled “2021”. Prior art node graph generation tools extract data elements from the worksheet data environment and create nodes and vertices to illustrate the relationships therebetween. The nodes represent the information provided in the cells, while the vertices represent the relationship between the nodes, based on the information provided in the worksheet data environment. As a result, the node graph shown in FIG. 3 illustrates that a node “2020” is connected to nodes “Revenues 2020”, “Profits 2020” and “Expenses 2020”. A node “REVENUES” is connected to the node “Revenues 2020” and a node “Revenues 2021”. A node “2021” is connected to the node “Revenues 2021”, a node “Profits 2021” and a node “Expenses 2021”. A node “EXPENSES” is connected to the nodes “Expenses 2020” and “Expenses 2021”. A node “PROFITS” is connected to the nodes ‘PROFITS 2020” and “PROFITS 2021”.

Those skilled in the art will understand that although the node graph illustrated in FIG. 3 correctly connects the various data elements of the first two columns of the table illustrated in FIG. 2, information is missing. The interconnections of data elements based on proximity, on visual structure and/or function are completely missing from the node graph of FIG. 3 which results in a significant loss of information. More particularly for the example shown in FIG. 3, those skilled in the art know that values referring to “PROFITS” usually correspond to a function, namely an operator, applied between the data elements “REVENUES” and “EXPENSES” as in the following equation:

$$PROFITS = REVENUES - EXPENSES$$

This equation is introduced as a function in the cells of the worksheet data environment for “Profits2020”, “Profits2021”, “Profits2022” and “Profits2023”, etc.

Thus, the node graph shown on FIG. 3 is lacking all functional information and the corresponding interconnections. Losing the functional information when extracting and correlating functional values and structural information from worksheet data environments has dire consequences as much of the knowledge and meaning provided by the worksheet data environment is embedded in the structure of the data in the worksheet data environment or the functions within the cells of the worksheet data environment. Thus, extracting only first-level information of worksheet data environment, namely the text, values, column titles, and row titles only provides top-level information and results in a complete loss of the structural and functional information embedded therethrough.

Reference is now concurrently made to FIGS. 1, 2, 4, and 5. The present method and system start with receiving or accessing a worksheet data environment by a computer (step 100). The computer may be local, remote, a server, or a cloud-based platform. For simplicity purposes, FIG. 2 illustrates an example of a small excerpt of a worksheet stored in the worksheet data environment. The worksheet data environment may include multiple worksheets, workbooks and/or other types of semi-structured data.

The method and system continue with extracting (step 110) for each functional value: the structural information provided in the worksheet data environment for the functional value. The structural information may include for example a row title for the row in which the functional value is stored in the worksheet data environment. The structural information may include a column title for the column in which the functional value is stored in the worksheet data environment. Although not shown, the structural information could further include a title and/or a subtitle for a section where the functional value is stored in the worksheet data environment, formatting information for the cell in which the functional value or the data element is stored. Furthermore, the structural information could further include a spreadsheet name, a worksheet name, a workbook name, or any other structural information which may be related to the functional value.

The method and system further extract (step 110) for each functional value data elements onto which a function is executed to generate the functional value. The data elements may include fixed values or at least one other functional value. In addition to extracting the data elements onto which the function is executed, the present method and system further extract the structural information of the data elements onto which the function is executed.

In worksheet data environments, functions are often used for creating layers of functional values. In the example of FIG. 2, a first layer of functional values is illustrated as “PROFITS”. A second layer of functional values include the “REVENUES” and “EXPENSES”. Each of these functional values are obtained upon execution of functions on subsets of other functional values (not shown) not shown on FIG. 2. The number of layers of functional values may vary depending on a structure of the worksheet data environment. The present method and system are adapted for extracting multiple layers of functional values and their corresponding structural information and interconnecting those layers of functional values.

The method and system further proceed with making interconnections (step 120) between the functional values, data elements, and structural information extracted. More particularly, each functional value is interconnected with the corresponding structural information extracted from the semi-structured environment. The interconnection may start with interconnecting the functional value with the corresponding row and column titles. Additionally, the interconnection may include interconnecting the functional value with a title for a section in which the functional value is stored, a title of the worksheet in which the functional value is stored, a tab name in which the functional value is stored, a workbook name in which the functional value is stored, i.e. from a micro perspective to a macro perspective in the worksheet data environment.

The method and system further proceeds with making interconnections (step 120) between the functional value and the data elements onto which the function is executed. The data elements onto which the function is executed may be grouped into a data element group, where each data element of the data element group share the same structural information, and the data element group is interconnected with the functional value instead or interconnecting each and every data element with the functional value. This approach of creating data element groups keeps the volume of extracted information smaller. The concept of data element groups is mostly used for data elements which are fixed values.

The method and system further proceeds with interconnecting (step 120) the structural information of the data elements (or the data element group if applicable) onto which the function is executed to obtain the functional value with the functional value. The proximity may be defined to correspond to an area of the worksheet data environment in which the function value is stored which could be visually inspected by a human.

The method and system may further proceed with interconnecting each of the functional values with proximal metadata, e.g. data elements proximately located in the worksheet data environment and the structural information of the data elements proximately located.

Those skilled in the art will understand that the interconnecting (step 120) may be performed concurrently while the functional values, the structural information, the data elements, and the structural information of the data elements are extracted, although shown on FIG. 1 as consecutive steps for illustration purposes only.

In an implementation, the extracted data elements, corresponding structural information, and interconnections are presented as unstructured data, such as for example text. The resulting text may follow a predetermined format or may be in freestyle.

In another implementation, the extracted data elements, corresponding structural information, and interconnections may be presented as structured data.

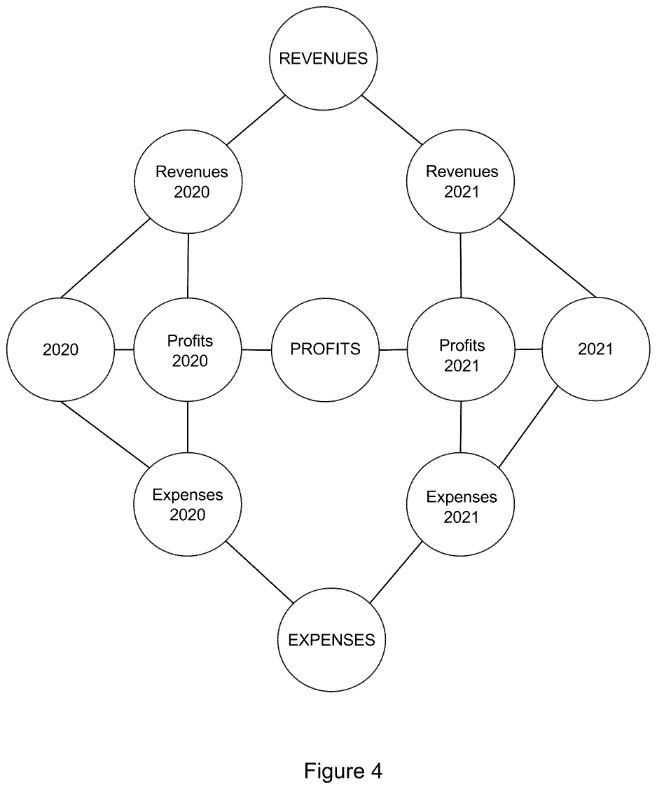

In a particular implementation, the extracted data elements, corresponding structural information, and interconnections may be presented as a node graph, such as shown in FIG. 4. The node graph could alternatively be a knowledge graph. Although the node graph in FIG. 4 shows undirected edges, the present method and system are not limited to such implementations of the node graph. For example, the node graph could be a directed graph, where the edges of data elements onto which the function is executed on could be directed towards the corresponding functional value.

The method and system then proceed with an optional step of cleaning (step 130) the extracted data elements and/or structural information. Depending on the type of information extracted from the worksheet data environment, or the source of the data elements, it might be valuable to proceed with a cleaning of the extracted data elements and/or structural information. The cleaning (step 130) may be performed using a trained Machine Learning (ML) engine or a Large Language Model. An ML engine could be trained for specifically cleaning specific types of worksheet data environments, such as for example worksheet data environments storing financially related information. The cleaning (step 130) of the node graph may update the information extracted for consistency purposes, may update the structural information extracted to standardized terminology, or any other type of cleaning which improves the consistency of the extracted data elements and structural information.

The method and system then proceed with a step of generating coherent compound information (step 140). The compound information corresponds to information that refers to a combination of data element, structural information, and interconnection(s). For worksheet data environments, examples of compound information may include: a comparison for a type of financial information, a comparison for a type of value, or a Key Performance Indicator (KPI). By extracting both the data elements and corresponding structural information of functional values and interconnecting the data elements and the structural information of functional values, compound information which was not previously directly accessible by prior art techniques the worksheet data environment can now be obtained.

If the extracted data elements, corresponding structural information, and interconnections are presented as a node graph, such as shown on FIG. 4, the compound information may be identified by performing a graph traversal process. The graph traversal process may be trivial, e.g. by performing a single forward pass through for example a transformer, or more complex such as a graph convolutional network which may proceed as a filter.

The method may be implemented in the form of a computer-readable medium storing instructions that, when executed by a computer, cause it to perform the method.

Those skilled in the art will understand that the present method and system are not limited to extracting and correlating functional values but could also be used to extract and correlate non-functional values and corresponding structural information. The present method and system could further generate coherent compound information for both functional and non-functional values and corresponding structural information.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A method for extracting and correlating functional values and structural information from a worksheet data environment, the method comprising:
extracting by a computer the functional values from the worksheet data environment;
for each functional value:
extracting by the computer structural information provided in the worksheet data environment for the functional values;
extracting data elements and structural information of the data elements onto which a function is executed to generate the functional value;
interconnecting the functional value with the corresponding structural information;
interconnecting the functional value with the data elements onto which the function is executed; and
interconnecting the structural information of the data elements onto which the function is executed to obtain the functional value.

2. The method of claim 1, wherein the worksheet data environment is at least one of: a spreadsheet, a worksheet, and a workbook.

3. The method of claim 1, wherein the structural information comprises at least one of: a row name, a column name, a title, visual proximate data elements and corresponding structural information, formatting information, and worksheet data environment hardcoded information.

4. The method of claim 1, comprising further interconnecting each of the functional values with visually proximate data elements.

5. The method of claim 1, wherein the function is one of: a financial function, a statistical function, a lookup function, a date and time function or a logical function.

6. The method of claim 1, wherein the node graph is a knowledge graph.

7. A method for generating coherent compound information in worksheet data environments, the method comprising:
accessing by a computer the worksheet data environment;
compound coherent information from the worksheet data environment by:
extracting by the computer functional values from the worksheet data environment;
for each functional value:
extracting by the computer structural information provided in the worksheet data environment for the functional values;
extracting data elements and structural information of the data elements onto which a function is executed to generate the functional value;
interconnecting the functional value with the corresponding structural information;
interconnecting the functional value with the data elements onto which the function is executed; and
interconnecting the structural information of the data elements onto which the function is executed to the functional value.

8. The method of claim 7, wherein the worksheet data environment is at least one of: a spreadsheet, a worksheet, and a workbook.

9. The method of claim 8, wherein the structural information includes at least one of: a row name, a column name, a title of a worksheet, a title of a section, a cell format, visually proximate data, and the worksheet data environment hardcoded information.

10. The method of claim 7, wherein the compound information consists of: a comparison for a type of financial information, a comparison for a type of value, or a Key Performance Indicator (KPI).

11. A computer-readable medium storing instructions that, when executed by a computer, cause it to perform the method of claim 1.
